(19) United States
(12) Patent Application Publication
(10) Pub. No.: US 2018/0306303 A1
(43) Pub. Date: Oct. 25, 2018

(54) RACK BAR AND RACK BAR MANUFACTURING METHOD

(71) Applicant: NETUREN CO., LTD., Tokyo (JP)

(72) Inventors: Koichi INAGAKI, Shinagawa-ku, Tokyo (JP); Wataru MATSUMOTO, Shinagawa-ku, Tokyo (JP)

(21) Appl. No.: 15/769,932

(22) PCT Filed: Oct. 20, 2016
(86) PCT No.: PCT/JP2016/004642

§ 371 Date: Apr. 20, 2018

(30) Foreign Application Priority Data
Oct. 22, 2015 (JP) 2015-208324

(51) Int. Cl. F16H 55/26; F16H 55/06; B62D 3/12; B29C 65/48; B29C 65/00

(52) U.S. Cl. CPC F16H 55/26; F16H 55/06; B62D 3/126; B29K 2307/04; B29C 66/721; B29C 66/5221; B29C 65/48

(57) ABSTRACT

A rack bar (10) includes a first bar member (11) having a first toothed portion (20), a second bar member (12) having a second toothed portion (21), and a joint member coaxially coupling the first and second bar members. The joint member (13) has a first joining portion (23) and a second joining portion (25) that are provided coaxially with each other. Each of the first and second joining portions has a hollow cylindrical shape. An inner peripheral surface of the first joining portion and an outer peripheral surface of an end portion (22) of the first bar member are joined to each other with an adhesive. An inner peripheral surface of the second joining portion and an outer peripheral surface of an end portion (24) of the second bar member are joined to each other with an adhesive.

### TECHNICAL FIELD

The present invention relates to a rack bar and a rack bar manufacturing method.

### BACKGROUND ART

Some vehicle steering apparatuses of an automobile and the like have a dual-pinion rack bar having rack toothed portions at two locations, one of the toothed portion meshing with a steering pinion of a steering shaft and the other toothed portion meshing with an assist pinion of an assisting mechanism. Depending on a positional relationship between the steering shaft and the assisting mechanism in the vehicle, the toothed portions at two locations on the dual-pinion rack bar may be designed to have a angular difference around an axis of the rack bar.

According to a related art method for manufacturing such a dual-pinion rack bar, with the aim of improving the accuracy of the angular difference between the toothed portions at two locations, a first bar member having a first toothed portion and a second bar member having a second toothed portion are coaxially arranged with a joint member being interposed between the first and second bar members, and the joint member is rotated about the axis such that an end face of the first bar member and an end face of the joint member are frictionally welded to each other and tan end face of the second bar member and the other end face of the joint member are frictionally welded to each other (see, e.g., JP2014-234882A).

In this related art, the first bar member, the second bar member and the joint member are joined at their end faces by friction welding, providing a relatively high strength even with a limited joining area. However, the materials of the first bar member, the second bar member and the joint member are basically limited to metal materials. For example, a carbon steel such as JIS-S45C typically used as the materials of the first and second bar members is also used as the material of the joint member. This has been a limitation on a weight reduction of dual-pinion rack bars.

### SUMMARY OF INVENTION

Illustrative aspects of the present invention provide a rack bar having toothed portions at two locations, with improved accuracy of an angular difference between toothed portions, and enabling weight reduction.

According to an illustrative aspect of the present invention, a rack bar includes a first bar member having a first toothed portion on which a plurality of rack teeth is formed, a second bar member having a second toothed portion on which a plurality of rack teeth is formed, and a joint member coaxially coupling the first bar member and the second bar member. The joint member has a first joining portion fitted onto an end portion of the first bar member and a second joining portion fitted onto an end portion of the second bar member. Each of the first joining portion and the second joining portion has a hollow cylindrical shape. The first joining portion and the second joining portion are formed coaxially with each other. An inner peripheral surface of the first joining portion of the joint member and an outer peripheral surface of the end portion of the first bar member are joined to each other with an adhesive. An inner peripheral surface of the second joining portion of the joint member and an outer peripheral surface of the end portion of the second bar member are joined to each other with an adhesive.

According to another illustrative aspect of the present invention, a method for manufacturing the rack bar is provided. The method includes applying the adhesive to at least one of the inner peripheral surface of the first joining portion of the joint member and the outer peripheral surface of an end portion of the first bar member, and fitting the end portion of the first bar member into the first joining portion, applying the adhesive to at least one of the inner peripheral surface of the second joining portion of the joint member and the outer peripheral surface of an end portion of the second bar member, and fitting the end portion of the second bar member into the second joining portion, and hardening the adhesives in a state in which the first toothed portion and the second toothed portion are adjusted to have a given angular difference around an axis of the rack bar.

### BRIEF DESCRIPTION OF DRAWINGS

FIG. 1 is a front view of an example of a steering apparatus according to an embodiment of the present invention.

FIG. 2 is a front view of a rack bar of the steering apparatus.

FIG. 3 is a cross-sectional view of the rack bar.

FIG. 4 is a enlarged perspective view of a portion surrounded by a broken line IV in FIG. 3.

FIG. 5 is a cross-sectional view of a modified example of the rack bar.

### DESCRIPTION OF EMBODIMENTS

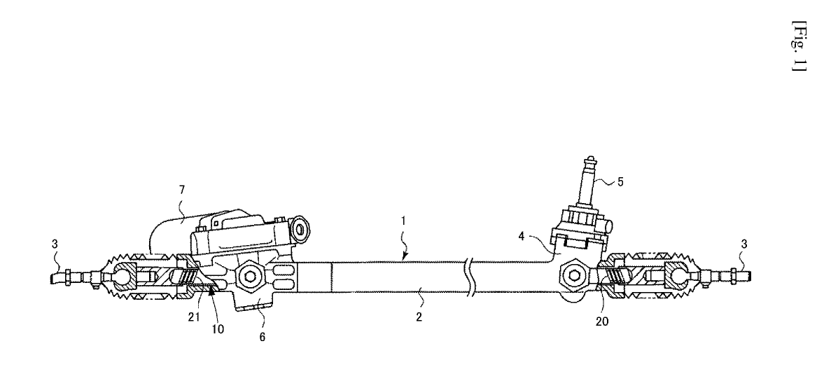

FIG. 1 illustrates a steering apparatus 1 according to an embodiment of the present invention.

The steering apparatus 1 has a rack housing 2 and a rack bar 10 housed in the rack housing 2 so as to be slidable in an axial direction.

To each end portion of the rack bar 10, a tie rod 3 is coupled through a joint, and by a movement of the rack bar 10, vehicle wheels are turned through the tie rod 3 and a steering mechanism to which the tie rod 3 is coupled.

At one axial end portion of the rack housing 2, a steering gear box 4 is provided. Inside the steering gear box 4, a steering pinion (not shown) formed on an input shaft 5 coupled to the steering shaft is provided. At the other axial end portion of the rack housing 2, an assist gear box 6 is provided. Inside the assist gear box 6, an assist pinion (not shown) driven by a motor 7 of an assisting mechanism is provided.

The rack bar 10 has a first toothed portion 20 and a second toothed portion 21. The first toothed portion 20 has a plurality of rack teeth meshing with the steering pinion. The second toothed portion 21 has a plurality of rack teeth meshing with the assist pinion.

By a rotating operation of a steering wheel, the steering pinion of the input shaft 5 is rotated, so that the rack bar 10 meshing with the steering pinion at the first toothed portion 20 is moved in the axial direction. The driving force of the motor 7 of the assisting mechanism controlled according to the steering force of the steering wheel and the like is transmitted to the rack bar 10 through the assist pinion meshing with the second toothed portion 21 to assist the movement of the rack bar 10 by the steering wheel rotating operation.

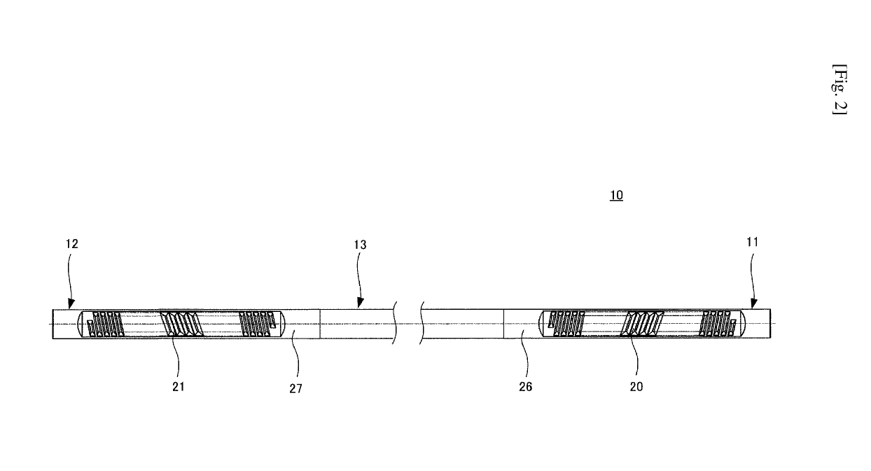

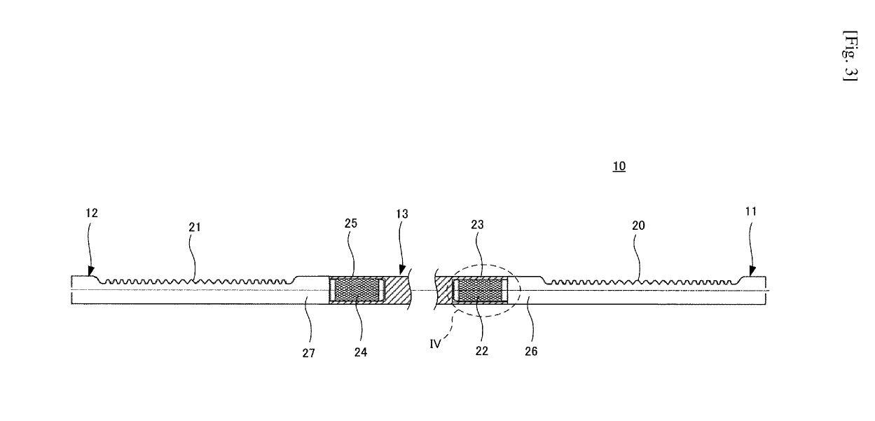

FIGS. 2 and 3 illustrate a structure of the rack bar 10.

The rack bar 10 has a first bar member 11 having the first toothed portion 20 with the rack teeth meshing with the steering pinion, a second bar member 12 having the second toothed portion 21 with the rack teeth meshing with the assist pinion, and a joint member 13 coupling the first bar member 11 and the second bar member 12 to each other.

The first bar member 11 and the second bar member 12 are made of solid rod members having a circular cross section and made of a metal material such as carbon steel such as JIS-S45C. The rack teeth of the first toothed portion 20 of the first bar member 11 and the second toothed portion 21 of the second bar member 12 are formed by, for example, cutting and/or forging. The tooth profiles of the rack teeth may be the same or different between the first toothed portion 20 of the first bar member 11 and the second toothed portion 21 of the second bar member 12, and a combination of a constant gear ratio (CGR) and a variable gear ratio (VGR) may be provided.

The joint member 13 is has a cylindrical shape, and is provided between the first bar member 11 and the second bar member 12 and coaxially with the first bar member 11 and the second bar member 12. The joint member 13 has a first joining portion 23 at one end of the joint member 13 and a second joining portion 25 at the other end of the joint member 13. The first joining portion 23 is fitted onto an end portion 22 of the first bar member 11, and the second joining portion 25 is fitted onto an end portion 24 of the second bar member 12. Each of the first joining portion 23 and the second joining portion 25 is formed to have a hollow cylindrical shape by providing a hole axially extending from a corresponding end face of the joint member 13. The first joining portion 23 and the second joining portion 25 are formed coaxially with each other.

The end portion 22 of the first bar member 11 is formed by cutting or the like to have a smaller diameter than a shaft portion 26 adjacent to the end portion 22. The end portion 24 of the second bar member 12 is formed by cutting or the like to have a smaller diameter than a shaft portion 27 adjacent to the end portion 24. The first bar member 11, the second bar member 12 and the joint member 13 all have the same outside diameter, so that the first bar member 11 and the joint member 13, and the second bar member 12 and the joint member 13 are connected to each other without any steps.

The outer peripheral surface of the end portion 22 of the first bar member 11 and the inner peripheral surface of the first joining portion 23 of the joint member 13 are joined to each other with an adhesive. The outer peripheral surface of the end portion 24 of the second bar member 12 and the inner peripheral surface of the second joining portion 25 and the joint member 13 are also joined to each other with the adhesive.

A plurality of recesses 28 may be formed on at least one of the outer peripheral surface of the end portion 22 of the first bar member 11 and the inner peripheral surface of the first joining portion 23 of the joint member 13 and on at least one of the outer peripheral surface of the end portion 24 of the second bar member 12 and the inner peripheral surface of the second joining portion 25 of the joint member 13. In the illustrated example, the recesses 28 are formed on each of the outer peripheral surface of the end portion 22 of the first bar member 11 and the outer peripheral surface of the end portion 24 of the second bar member 12. By the recesses 28, the area of contact between the surface where the recesses 28 are formed and the adhesive increases, and further, an anchor effect of the adhesive having entered the recesses 28 and hardened is caused, so that the joint strength is improved.

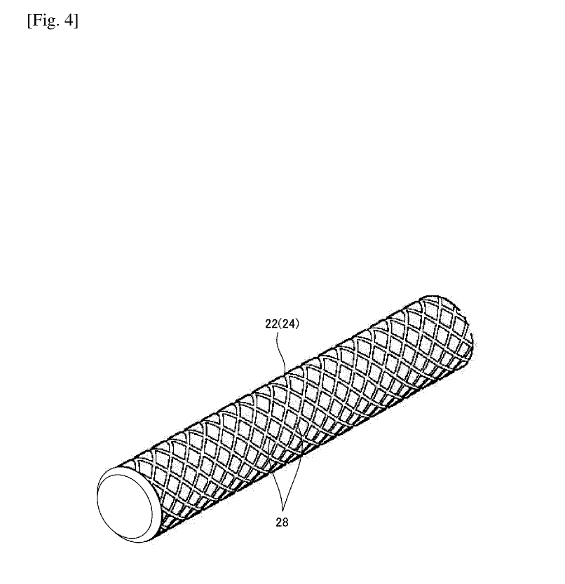

The recesses 28 may be formed in the shape of grooves by knurling as shown in FIG. 4, may be formed in the shape of dots by dimpling, or they are not limited to visible coarse ones formed by knurling or dimpling but may be minute ones formed by roughening such as shot blasting.

The rack bar 10 is manufactured as follows:

First, the first bar member 11 having the first toothed portion 20 on which the rack teeth are formed, the second bar member 12 having the second toothed portion 21 on which the rack teeth are formed, and the joint member 13 are prepared. Then, the adhesive is applied to at least one of the outer peripheral surface of the end portion 22 of the first bar member 11 and the inner peripheral surface of the first joining portion 23 of the joint member 13 and to at least one of the outer peripheral surface of the end portion 24 of the second bar member 12 and the inner peripheral surface of the second joining portion 25 of the joint member 13. It is preferable that the adhesive is applied to at least the surface having the recesses 28.

The end portion 22 of the first bar member 11 is fitted into the first joining portion 23 of the joint member 13. The end portion 24 of the second bar member 12 is fitted into the second joining portion 25 of the joint member 13. The first bar member 11, the second bar member 12, and the joint member 13 are provided coaxially with each other.

The first joining portion 23 and the second joining portion 25 of the joint member 13, each having a hollow cylindrical shape, are formed coaxially with each other, so that the first bar member 11 and the second bar member 12 can be rotated about the axis to adjust the first toothed portion 20 of the first bar member 11 and the second toothed portion 21 of the second bar member 12 to have a given angular difference around the rotation axis.

Then, in a state in which the first bar member 11 and the second bar member 12 are respectively held such that they are unrotatable about their rotation axis, the adhesive interposed between the end portion 22 of the first bar member 11 and the first joining portion 23 of the joint member 13 and the adhesive interposed between the end portion 24 of the second bar member 12 and the second joining portion 25 of the joint member 13 are hardened, whereby the first bar member 11 and the second bar member 12 are coaxially coupled to each other via the joint member 13.

By manufacturing the rack bar 10 in a manner described above, the angular difference between the first toothed portion 20 of the first bar member 11 and the second toothed portion 21 of the second bar member 12 can be easily controlled, and its accuracy can be improved.

Since the first bar member 11 and the joint member 13, and the second bar member 12 and the joint member 13 are joined at the inner and outer peripheral surfaces extending in the axial direction, the joining area can be made large compared with a case where they are joined at end faces, so that sufficient strength can be provided even with adhesives. Thereby, as the material of the joint member 13 which is basically limited to a metal material in the case of friction welding, a non-metal material typically lower in specific gravity than metal materials such as carbon steel like JIS-S45C used as the material of the first bar member 11 and the second bar member 12 can also be used, so that the weight of the rack bar 10 can be reduced.

As the non-metal material of which the joint member 13 is made, a fiber reinforced resin material may be suitably used from the viewpoint of mechanical strength such as hardness and toughness, and specific gravity.

As the fiber contained in the fiber reinforced resin material, various fibers such as glass fiber, aramid fiber and carbon fiber may be used, and of all, carbon fiber may be suitably used. The carbon fiber reinforced resin material is also excellent in vibration damping property, are capable of damping various vibrations acting on the rack bar 10 such as vibrations resulting from road surface unevenness and vibrations resulting from braking imbalance and rotation imbalance of wheels, and are capable of improving steering feeling by suppressing transmission of these vibrations to the driver through the steering shaft and the steering wheel. Moreover, by damping vibrations, vehicle quietness can also be improved.

As the matrix resin forming the fiber reinforced resin material, a thermosetting resin or a thermoplastic resin, or a mixed resin of a thermosetting resin and a thermoplastic resin may be used. As the thermosetting resin, epoxy resin, unsaturated polyester resin and phenol resin may be cited as examples, and as the thermoplastic resin, polypropylene resin, polyamide resin and polyphenylene sulfide resin may be cited as examples.

As the non-metal material of which the joint member 13 is made, a fiber reinforced ceramic material may also be used.

Examples of adhesives that may be used to join the end portion 22 of the first bar member 11 and the first joining portion 23 of the joint member 13, and the end portion 24 of the second bar member 12 and the second joining portion 25 of the joint member 13, include thermosetting adhesives such as one-component epoxy adhesives, cold setting adhesives such as two-component epoxy adhesives, two-component acrylic adhesives and polyurethane adhesives; and thermoplastic adhesives such as polyolefin adhesives. The adhesives may be selected depending on the materials of the first bar member 11, the second bar member 12 and the joint member 13.

For example, when the material of the first bar member 11 and the second bar member 12 is a carbon steel such as JIS-S45C and the material of the joint member 13 is a carbon fiber reinforced resin material the matrix resin of which is a thermosetting resin, a thermosetting adhesive may be suitably used as the adhesive. When the material of the first bar member 11 and the second bar member 12 is a carbon steel such as JIS-S45C and the material of the joint member 13 is a carbon fiber reinforced resin material the matrix resin of which contains a thermoplastic resin, a cold setting adhesive may be suitably used.

When applying the adhesive to at least one of the outer peripheral surface of the end portion 22 of the first bar member 11 and the inner peripheral surface of the first joining portion 23 of the joint member 13 and to at least one of the outer peripheral surface of the end portion 24 of the second bar member 12 and the inner peripheral surface of the second joining portion 25 of the joint member 13, it is preferable to reduce the viscosity of the adhesive by heating the adhesive to the softening temperature not only for the thermoplastic adhesive but also for the thermosetting adhesive and the cold setting adhesive. In this way, the adhesive can be applied uniformly, so that the joint strength between the first bar member 11 and the joint member 13 and the joint strength between the second bar member 12 and the joint member 13 are improved.

It is also effective to reduce the viscosity of the adhesive by heating the adhesive to the softening temperature in a state in which the adhesive is provided between the first joining portion 23 of the joint member 13 and the end portion 22 of the first bar member 11 fitted in the first joining portion 23 and/or the adhesive is provided between the second joining portion 25 of the joint member 13 and the end portion 24 of the second bar member 12 fitted in the second joining portion 25. In this way, the degree of adhesion of the adhesive can be enhanced, so that the joint strength between the first bar member 11 and the joint member 13 and the joint strength between the second bar member 12 and the joint member 13 are improved.

The heating of the adhesive in a state in which the first bar member 11 and the second bar member 12 are inserted in the joint member 13 may be performed by, for example, infrared heating, hot-air heating or the like. In other instances, the end portion 22 of the first bar member 11 and the end portion of the second bar member 12 made of a metal material such as carbon steel may be inductively heated and the adhesive in contact with the end portions 22, 24 is heated by the heat caused at the end portions 22, 24. With the induction heating, the heating temperature of the adhesive can be easily controlled by current amount and current applying time. Moreover, according to the induction heating, the end portions 22, 24 can be heated locally and quickly, deterioration and distortion, due to heat, of the part of the first bar member 11 except the end portion 22, the part of the second bar member 12 except the end portion 24 and the part of the joint member 13 fitted onto the end portions 22, 24 except the first joining portion 23 and the second joining portion 25 can be suppressed, and further, deterioration and distortion, due to heat, of the external layers of the first joining portion 23 and the second joining portion 25 of the joint member 13 forming the outer surface of the rack bar 10 can be suppressed.

When the adhesive is the thermosetting adhesive, the first toothed portion 20 of the first bar member 11 and the second toothed portion 21 of the second bar member 12 that are fitted in the joint member 13 are adjusted to have a given angular difference around the axis, the first bar member 11 and the second bar member 12 are held, and then, the thermosetting adhesive is heated to the curing temperature and hardened. As described above, by using the thermosetting adhesive, the adjustment of the angular difference between the first toothed portion 20 and the second toothed portion 21 and the fixing of the first bar member 11 and the second bar member 12 can be performed with a margin.

The heating when the thermosetting adhesive is hardened may be, for example, infrared heating or hot-air heating or may be induction heating. According to the induction heating, as described above, deterioration and distortion, due to heat, of the part of the first bar member 11 except the end portion 22, the part of the second bar member 12 except the end portion 24 and the part of the joint member 13 fitted onto the end portions 22, 24 except the first joining portion 23 and the second joining portion 25 can be suppressed, and further, deterioration and distortion, due to heat, of the external layers of the first joining portion 23 and the second joining portion 25 of the joint member 13 forming the outer surface of the rack bar 10 can be suppressed.

Here, the carbon fiber reinforced resin material (specifically, carbon fibers contained in the carbon fiber reinforced resin material) is a material having conductivity and being higher in potential than carbon steel such as JIS-S45C and if the joint member 13 made of the carbon fiber reinforced resin material is in direct contact with the first bar member 11 and the second bar member 12 made of carbon steel, electric corrosion can occur on the first bar member 11 and the second bar member 12; however, in the rack bar 10, the adhesive is interposed between the end portion 22 of the first bar member 11 and the first joining portion 23 of the joint member 13 and between the end portion 24 of the second bar member 12 and the second joining portion 25 of the joint member 13 and by the adhesive, the end portion 22 of the first bar member 11 and the first joining portion 23 of the joint member 13, and the end portion 24 of the second bar member 12 and the second joining portion 25 of the joint member 13 are separated from each other, so that electric corrosion of the first bar member 11 and the second bar member 12 can be suppressed.

The suppression of electric corrosion by the adhesive applies to a case where the material of the joint member 13 has conductivity and is higher in potential than the material of the first bar member 11 and the second bar member 12, and is not limited to the combination of carbon steel and the carbon fiber reinforced resin material.

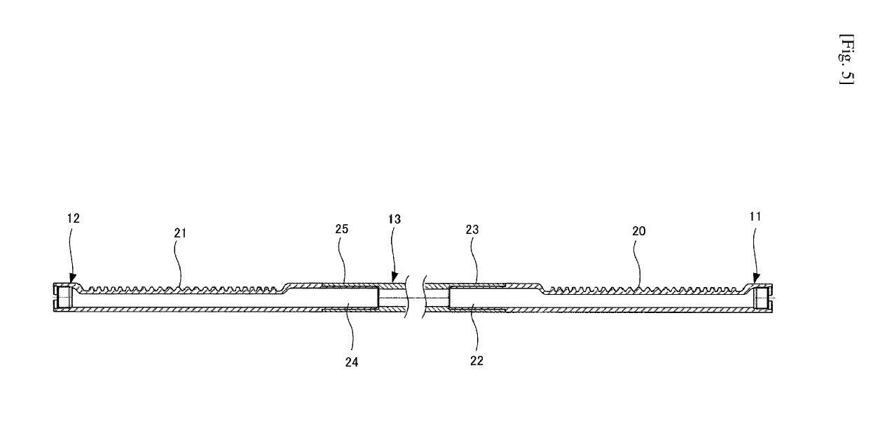

FIG. 5 shows a modification of the rack bar 10.

In the example shown in FIG. 5, the first bar member 11 and the second bar member 12 are made of a pipe member that is circular in cross section and the joint member 13 is also formed in the shape of a circular tube and is made hollow over the entire length of the rack bar in the axial direction, whereby the rack bar is further reduced in weight.

While the first bar member 11 and the second bar member 12 are pipe members in the illustrated example, one of the first bar member 11 and the second bar member 12 may be a pipe member and the other of the first bar member 11 and the second bar member 12 may be a rod member. Further, the joint member 13 may have a cylindrical shape as shown in FIGS. 2 and 3.

With the first and second bar members 11, 12 being pipe members, the rack teeth of the first toothed portion 20 of the first bar member 11 and the rack teeth of the second toothed portion 21 of the second bar member 12 are formed, for example, as follows.

First, a flat teeth forming surface is preliminary formed at a portion of the pipe member to be toothed (hereinafter, a teeth forming portion), the portion being a part of the pipe member in its longitudinal direction. The teeth forming surface is formed, for example, by press working that crushes the teeth forming portion of the pipe member by using a forming die.

Then, the pipe member is placed in a forming die including a teeth die pressed against the teeth forming surface and surrounding the teeth forming portion of the pipe member over the entire periphery, and a core metal is inserted into the pipe member. The thickness part of the pipe member forming the teeth forming surface is squeezed from the inside by the inserted core metal, and enters the teeth die pressed against the teeth forming surface. As the thickness of the inserted core metal is gradually increased and squeezing is repeated, a plurality of rack teeth corresponding to the teeth die are formed on the pipe member.

The first joining portion 23 and the second joining portion 25 at the end portions of the pipe-shaped joint member 13 have a hollow cylindrical shape and are disposed coaxially with each other. The first joining portion 23 is fitted onto the end portion 22 of the first bar member 11, and the second joining portion 25 is fitted onto the end portion 24 of the second bar member 12.

Then, the outer peripheral surface of the end portion 22 of the first bar member 11 and the inner peripheral surface of the first joining portion 23 of the joint member 13 are joined to each other with the adhesive, the outer peripheral surface of the end portion 24 of the second bar member 12 and the outer peripheral surface of the second joining portion 25 of the joint member 13 are joined to each other with the adhesive, and the first bar member 11 and the second bar member 12 are coaxially coupled to each other via the joint member 13.

While present invention has been described with reference to certain embodiments thereof, the scope of the present invention is not limited to the embodiments described above, and it will be understood by those skilled in the art that various changes and modifications may be made therein without departing from the scope of the present invention as defined by the appended claims.

This application is based on Japanese Patent Application No. 2015-208324 filed on Oct. 22, 2015, the entire content of which is incorporated herein by reference.

1. A rack bar comprising:
a first bar member comprising a first toothed portion on which a plurality of rack teeth is formed;
a second bar member comprising a second toothed portion on which a plurality of rack teeth is formed; and
a joint member coaxially coupling the first bar member and the second bar member, wherein the joint member comprises a first joining portion fitted onto an end portion of the first bar member and a second joining portion fitted onto an end portion of the second bar member, each of the first joining portion and the second joining portion having a hollow cylindrical shape, and the first joining portion and the second joining portion being formed coaxially with each other,
wherein an inner peripheral surface of the first joining portion of the joint member and an outer peripheral surface of the end portion of the first bar member are joined to each other with an adhesive, and
wherein an inner peripheral surface of the second joining portion of the joint member and an outer peripheral surface of the end portion of the second bar member are joined to each other with an adhesive.

2. The rack bar according to claim 1, wherein a plurality of recesses are formed on at least one of the inner peripheral surface of the first joining portion of the joint member and the outer peripheral surface of the end portion of the first bar member, and
wherein a plurality of recesses are formed on at least one of the inner peripheral surface of the second joining portion of the joint member and the outer peripheral surface of the end portion of the second bar member.

3. The rack bar according to claim 1, wherein the joint member is made of a non-metal material.

4. The rack bar according to claim 3, wherein the non-metal material is a fiber reinforced resin material.

5. The rack bar according to claim 4, wherein the fiber reinforced resin material contains carbon fibers.

6. A method for manufacturing a rack bar, the rack bar comprising a first bar member having a first toothed portion on which a plurality of rack teeth are formed, a second bar member having a second toothed portion on which a plurality of rack teeth are formed, and a joint member coaxially coupling the first bar member and the second bar member, wherein the joint member comprises a hollow cylindrical first joining portion at one end of the joint member and a hollow cylindrical second joining portion at another end of the joint member, the first joining portion and the second joining portion being formed coaxially with each other, the method comprising:
applying an adhesive to at least one of an inner peripheral surface of the first joining portion of the joint member and an outer peripheral surface of an end portion of the first bar member, and fitting the end portion of the first bar member into the first joining portion;
applying an adhesive to at least one of an inner peripheral surface of the second joining portion of the joint member and an outer peripheral surface of an end portion of the second bar member, and fitting the end portion of the second bar member into the second joining portion; and
hardening the adhesives in a state in which the first toothed portion and the second toothed portion are adjusted to have a given angular difference around an axis of the rack bar.
